(19) United States
(12) Patent Application Publication
(10) Pub. No.: US 2003/0001025 A1
(43) Pub. Date: Jan. 2, 2003

(54) Showerhead leak detector and shutoff

(76) Inventor: Richard Quintana, Westminster, CA (US)

Correspondence Address: KLEIN, O'NEILL & SINGH, 2 PARK PLAZA, SUITE 510, IRVINE, CA, 92614, US

(21) Appl. No.: 09/895,460

(22) Filed: Jun. 29, 2001

(51) Int. Cl. B67D 5/08; B05B 1/30; B05B 1/00

(52) U.S. Cl. 239/71; 239/589; 239/548; 239/581.1

(57) ABSTRACT

A microprocessor-operated valve is held in a showerhead to shut off flow of water if a leak detector measures any water leakage. The valve is mounted in a conduit in the showerhead and operated to shut off water flow if the water leak detector senses leakage from the showerhead. An electric motor is held in the showerhead and actuated to drive a gear train to close the normally-open valve and shut off water flow through the conduit.

### BACKGROUND OF THE INVENTION

1. Field of the Invention

This invention relates generally to fluid control devices, and more particularly, to a showerhead, having a sensor for detecting any leaks and automatically shutting off the flow of water through the showerhead to avoid wastage.

2. Description of Related Art

As homeowners and others are well aware, if appliances, sinks, showerheads, and the like, that use water are not connected properly, or as they get older, they may leak. Such leakage, if not stopped, can cause unsightly stains, waste large amounts of water, or cause flooding, which may result in unwanted cost and/or serious problems. Furthermore, with the increase in population and use of water, water is becoming scarce and conservation is becoming increasingly more important. Therefore, the detecting and prevention of water leaks to save water when using showerheads and other devices has become a priority.

The present invention incorporates a leak detecting sensor that is secured in a desired location in a showerhead. The sensor is programmed to transmit a signal to a control device connected to a low-voltage, rechargeable battery or other type power source for energizing a motor to operate a valve to cut off water flow through the showerhead.

The present invention further includes a reset button that indicates that the showerhead has been shut off, and which must be reset before the showerhead may be used further.

### SUMMARY OF THE INVENTION

Accordingly, it is a general object of the present invention to provide an improved and simplified showerhead flow control and leak detector device. It is a particular object of the present invention to provide an improved and simplified showerhead water flow control and leak detector device, including a sensor that is mounted in a desired location in the showerhead. It is yet another particular object of the present invention to provide an improved and simplified showerhead water flow control and leak detector system, having a separate leak detecting portion, and a motor operated shutoff valve. It is still another particular object of the present invention to provide an improved and simplified microprocessor controlled showerhead shutoff device having a leak sensing member mounted adjacent a flow conduit therethrough. It is a further particular object of the present invention to provide an improved and simplified showerhead water flow control device having a microprocessor-operated drive motor connected to a power source held in the showerhead for operating a shutoff valve means when a leak detector mounted in the showerhead determines that there is a water leak. And, it is a still further object of the present invention to provide a showerhead leak detector and shutoff means having an accoustical detector and an indicating means therein.

These and other objects and advantages of the present invention are achieved by providing a showerhead having a built-in leak detecting means mounted in a pre-selected location and electrically connected, between a power source and an electric motor for activating a gear-operated valve held in the showerhead.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, wherein:

FIG. 1 is a side elevational view, partially in cross-section, showing a showerhead of the present invention having a gear-operated valve means mounted in a conduit to control water flow through the showerhead, together with a leak detector mounted on the conduit and electrically connected between a power source, a mircoprocessor and a motor for actuating the valve means;

FIG. 2 is a partial diagramatic perspective view of the interior of the showerhead of the present invention;

FIG. 3 is a partial cross-sectional view of the conduit, with shutoff valve in the open position; and

FIG. 4 is a further partial cross-sectional view of the conduit of FIG. 3, with the shutoff valve in the closed position.

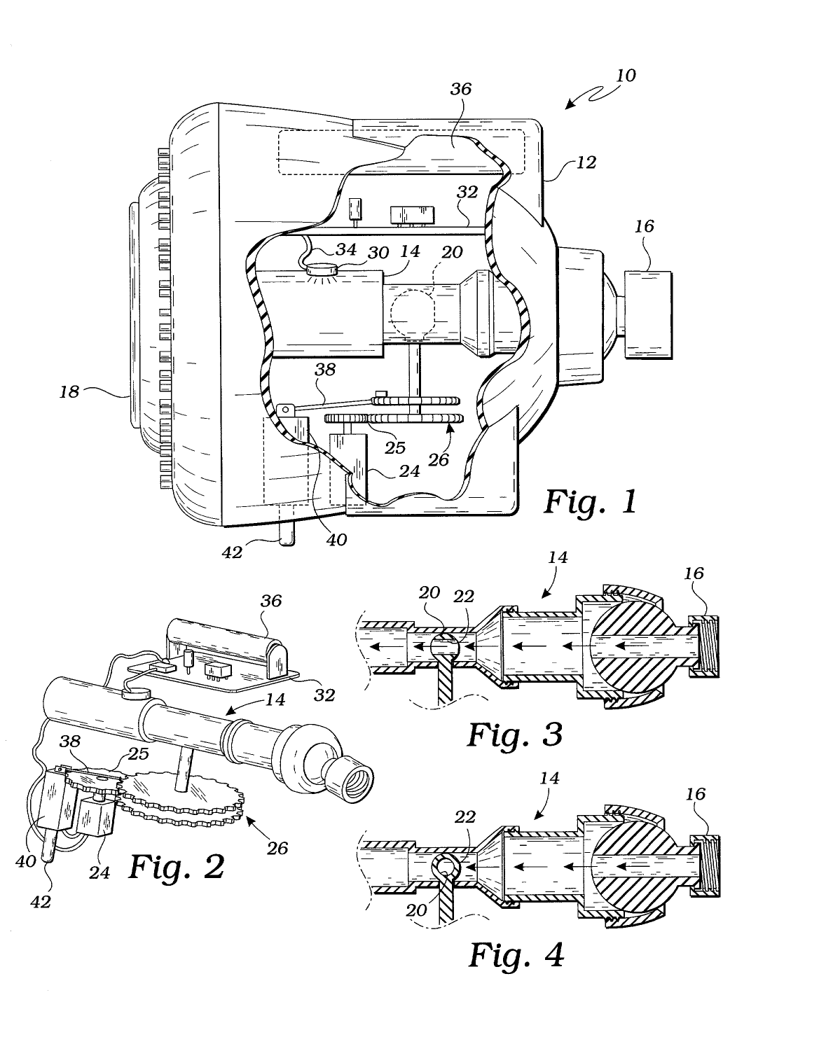

### DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide for an improved and simplified showerhead water leak detector and shutoff valve. A showerhead 10 is shown having a body 12 with an internal flow conduit 14 connected between an inlet 16 and a massage or other type head 18. A gear-actuated valve 20, such as a ball valve, is held in the conduit 14. Shower water will normally enter inlet 16, pass through internal flow conduit 14, and through a passage 22 in the normally open valve 20 to exit through the massage head 18.

However, if a water leak is detected from or in the showerhead 20, as explained more fully below, a motor 24 will be actuated to drive a gear 25 to turn valve 20 ninety degrees (90°) to the closed position shown in FIG. 4, so as to cut off water flow through the showerhead. The gear 25 may drive a single gear 26, connected to a drive shaft 28 connected to valve 20, or may be connected to a drive train having a plurality of gears to operate the valve 20. The number and size of gears used in the drive train will depend on the size of the showerhead 10, and the motor 24, and how fast it is desired to close and open valve 20.

A leak detector 30, which may be of any type, but which is preferably of the acoustical type, such as a microphone, is secured in a pre-selected area to the exterior of the conduit 14. The leak detector 30 is directly connected to a microprocessor 32 by a lead 34. The microprocessor is connected to a self-contained internal power source, such as a battery 36 held in a watertight compartment 37. When a leak is detected by detector 30 a signal is sent to the microprocessor 32, and motor 24 is actuated by the power source 36 to rotate and close the normally open valve 20, approximately 90°, by means of the gear drive system 25, 26 in the body 12. Upon closing of valve 20, water flow in conduit 14 will be shut off. When the motor 24 turns gears 25, 26 to the water shutoff position, it actuates a lever 38 to actuate a switch 40, such as a microswitch. When switch 40 is actuated, a button 42, preferably colored red or some other bright color, is actuated or released to indicate that valve 20 is closed and that water flow through the showerhead 10 has been interrupted. The leak may then be repaired and the button 40 reset to operate the motor 24 to return the valve 20 to the open position shown in FIG. 3.

The leak detector 30 mounted on the conduit 14 must be calibrated or set so as to only operate motor 24 to close the valve when it senses a slow leak or drip from the showerhead, and not when there is a continuous flow of water through conduit 14, during normal use of the showerhead. This calibration can be programmed into the microprocessor 32.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A showerhead having a combination water flow control and leak detecting device therein, comprising:
a body having an inlet, an outlet and a through conduit connected therebetween;
a leak detector sensor held in the body;
a power source held in the body and connected to the leak detector sensor; and
means for connecting the leak detector sensor to a motor-actuated, normally-open valve held in the conduit, to control the flow of water through the conduit.

2. The showerhead of claim 1, further including a motor connected to the valve; the motor being secured within the body.

3. The showerhead of claim 2, further including a switch, actuated by the motor-actuated, normally-open valve, when the valve is in the closed position.

4. The showerhead of claim 3, further including a plurality of gears connected between the motor and the valve.

5. The showerhead of claim 4, further including a button on the switch to indicate that the normally-open valve is closed.

6. The showerhead of claim 1 wherein the leak detector sensor is secured to an exterior surface of the conduit, the motor-actuated, normally-open valve has a gear drive mounted between an electrical motor held in the body and a rotary valve element held in the conduit.

7. The showerhead of claim 6, further including a microprocessor held in the body and connected between the power source, the leak detector sensor and a motor for actuating the rotary valve element.

8. A combination water flow control and water leak detecting device held in a showerhead, comprising:
a body having an inlet, an outlet and a through conduit connected therebetween;
a leak detector sensor secured to an exterior surface of the conduit within the body;
a microprocessor motor-operated, normally-open valve, including a gear drive and an electrical power source held in the body to control the flow of water through the conduit; and
means for connecting the leak detector sensor to the microprocessor.

9. The combination water flow control and water leak detecting device of claim 8 wherein the leak detector sensor is a microphone.

10. The combination water flow control and water leak detecting device of claim 9, further including a switch held in the body, which switch is actuated when the normally-open valve is closed.

11. The combination water flow control and water leak detecting device of claim 10 wherein the switch includes a reset button that is in an extended position, outside of the body, when the normally-open valve is closed.

12. The combination water flow control and water leak detecting device of claim 11 wherein the normally-open valve is a ball valve and the gear drive includes a plurality of gears connected to a shaft secured to the ball valve.

13. The combination water flow control and water leak detecting device of claim 10 wherein the power source is at least one battery held in a housing formed in the body

14. The combination water flow control and water leak detecting device of claim 8 wherein the motor-actuated, normally-open valve has a gear drive mounted between an electrical motor held in the body and a ball valve element held in the conduit.

15. The combination water flow control and water leak detecting device of claim 14 wherein the power source is at least one battery held in the body, and the body has a reset switch mounted therein, operatively connected to the gear drive.

16. A combination water flow control and leak detecting device for a showerhead, comprising:
a leak detector mounted on a conduit passing between an inlet and an outlet of the showerhead;
a gear-driven, motor-actuated, normally-open valve, held in the conduit to control flow of water therethrough; and
a microprocessor and a power source held in the showerhead and operatively connected between the leak detector and an electric motor to control the flow of water through the conduit.

17. The combination water flow control and leak detecting device for a showerhead of claim 16 wherein the leak detector includes a microphone to transmit a signal to the microprocessor to close the normally-open valve if a leak is detected.

18. The combination water flow control and leak detecting device for a showerhead of claim 17 wherein there are a plurality of gears held between the electric motor and the normally-open valve, and a switch is operated by at least one of the plurality of gears when the normally-open valve is closed, and, the switch includes an indicating means thereon.

19. The combination water flow control and leak detecting device of claim 18 wherein the indicating means is a reset button that extends from an outer surface of a body of the showerhead.

20. The combination water flow control and leak detecting device of claim 16 wherein the normally-open valve is actuated approximately 90°, between the normally-open position and a closed position, by a gear drive held between an electric motor and a ball valve element; and the electric motor is connected to the microprocessor and a battery held in the showerhead.
